(19) United States
(12) Patent Application Publication
(10) Pub. No.: US 2016/0321935 A1
(43) Pub. Date: Nov. 3, 2016

(54) PARTICIPANT OUTCOMES, GOAL MANAGEMENT AND OPTIMIZATION, SYSTEMS AND METHODS

(71) Applicant: MERCER (US) INC., New York, NY (US)

(72) Inventors: Sherman Mohler, Gilbert, AZ (US); Sam Espinosa, Phoenix, AZ (US); Mark A. Viloria, Round Rock, TX (US); Alexander Domaszewicz, Newport Beach, CA (US); Gary Olliffe, Bedfordshire (GB); Katie Stein, New York, NY (US); Gareth Williams, Novato, CA (US); Louis Gagnon, Ann Arbor, MI (US); Gerard Murphy, San Francisco, CA (US)

(73) Assignee: MERCER (US) INC., New York, NY (US)

(21) Appl. No.: 14/285,496

(22) Filed: May 22, 2014

Related U.S. Application Data
(60) Provisional application No. 61/826,248, filed on May 22, 2013.

(51) Int. Cl. G09B 5/08

(52) U.S. Cl. CPC G09B 5/08

(57) ABSTRACT

A goal optimization ecosystem is presented. Contemplated systems include a database storing participant data representing aspects across the life of one or more participants. The system further includes a goal database storing one or more goal objects representing a participant's objectives in life. As participant data flows through a goal engine, the goal engine tracks the progress toward objectives of the objective objects and can calculated a life score reflecting a balance or level of optimization between the goals. Further, the goal engine can make recommendations on participant actions that can alter the likelihood that the objectives could be achieved individually and the value of the life score.

This application claims priority to U.S. provisional application 61/826,248, filed May 22, 2013. U.S. provisional application 61/826,248 and all other extrinsic references contained herein are incorporated by reference in their entirety.

### FIELD OF THE INVENTION

The field of the invention is data acquisition and analysis technologies.

### BACKGROUND

The following description includes information that may be useful in understanding the present invention. It is not an admission that any of the information provided herein is prior art or relevant to the presently claimed invention, or that any publication specifically or implicitly referenced is prior art.

Many large corporate entities have access to large data sets, commonly referred to as “Big Data”, while lacking an ability to leverage such big data. Lacking an ability to analyze such big data is especially problematic in industries that store or house massive amounts of data relating to individuals' financial or health state. Analyzing such information could be of benefit to the corporate entity, its clients, employees, or other stakeholders. If suitable technologies existed, the entity could distill the data to aid in financial planning, benefit planning, personal goal management, community goal management, family management, legacy management, or other capabilities. Further, if such technologies were available, the entity could provide feedback services, reconciliation services, optimization service, or other services to its clients, employees, or other stakeholders.

Others have put forth efforts towards assisting individuals with goal-setting. For example, U.S. pre-grant publication 2008/0109257 A1 to Albrecht, et al, is directed to an assessment tool using a holistic well-being improvement model. However, Albrecht lacks discussion regarding the relationship between goals across different categories or life channels.

U.S. pre-grant publication 2012/0239416 A1 to Langva discusses a lifestyle management tool used to determine a work optional dates, estimated date of death, and a net present value of the user's financial state. While Langva discusses financial and non-financial aspects of a user's life, the discussion of non-financial aspects is limited to extending longevity and/or a possible date of retirement and only looks at non-financial aspects of a user's life in terms of time or financial expenses. Thus, Langva fails to consider a balance for a user for whom financial goals or retirement are not the only priority.

U.S. pre-grant publication 2006/0184409 A1 to Bangel, et al is directed to systems and methods of managing goals. While Bangel discusses a balance of goals, the balance is limited to a comparing the number of goals in various categories and trying to equalize the number of goals. Additionally, Bangel lacks a discussion of an interaction or relationship between various goals across different areas of a user's life.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for big data goal optimization systems that capable of assessing the short-term and long-term goals and needs across multiple areas of a person's life and accurately incorporating the relationships and effects the various areas of a person's life have on one another.

### SUMMARY OF THE INVENTION

The inventive subject matter provides apparatus, systems and methods in which a one can leverage vast quantities of data related to system participants to aid the participants in optimizing their life goals. One aspect of the inventive subject matter includes a goal optimization system that includes a participant database, a goal database, a participant interface, and a goal engine. The participant database is preferably configured or programmed to store vast amounts of participant data across a broad spectrum of participants. Example participant data can include biometric data, life choices, demographics, psychographics, team data, or other types of participant data. The goal database can be configured to store one or more goal objects representing one or more participant's goals possibly including financial goals, family goals, legacy goals, societal goals, or other types of goals. The goal engine can create one or more goal objects based on participant input (e.g., participant data, goal definitions, etc.) received via the participant interface.

The engine can generate a life score based on the various goal objects, reflecting a balance among the various goals and the effects of the interactions between the goal attributes of the goal objects.

In calculating the life score, the engine can further compare the nature of the goal object to other known goal objects with respect to various participants to generate a likelihood that the participant can achieve the objectives of the goal object. The engine can further use the life score, the calculated likelihoods and/or goal attributes of various goal objects to generate one or more goal recommendations that can include actions to be taken by one or more participants where the recommendations seek to alter the likelihood in a desired direction if the actions are taken.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates a schematic of a big data goal optimization ecosystem.

FIG. 2 illustrates an example process as executed by the system, of generating goal objects, a life score, a recommendation based on the life score and updating the goal objects, life score and recommendations.

FIG. 3 provides an example view of a goal object.

FIG. 4 provides a detailed view of generating a goal object for an exemplary use case illustrating retirement planning goal objects, including associated goal likelihoods and recommendations.

FIG. 5 is an illustration of a life score and a set of goals presented to a user via the participant interface according to one presentation alternative.

FIG. 6 is an illustration of a life score and a set of goals presented to a user via the participant interface according to one presentation alternative according to a second presentation alternative.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networking environment, the terms “coupled to” and “coupled with” are also used euphemistically to mean “communicatively coupled with” where two or more network-enabled devices are able to exchange data over a network with each other, possibly via one or more intermediary devices.

The disclosed techniques allow an entity to compile, analyze, or otherwise manage large data sets in order to provide useful services to data stakeholders (e.g., the entity itself, clients of the entity, employees of the client, individual participants, etc.). The following discussion is presented within the context of a corporate entity that provides access to workplace data, possibly including talent data, health data, retirement data, investments data, benefits data, outsourcing data, M&A data, or other types of data. The term “entity” is used to represent a stakeholder that operates one or more computing services capable of compiling and analyzing data, and then capable of providing analysis results to other stakeholders, preferably for a fee. Further the term “participant” is used to represent an end user that can provide participant data to the system or consume the goal optimization services of the system. Typically a participant includes an employee of a client that purchases services from the entity. However, a participant could also include the client, or other end user.

Through the use of the disclosed technologies, entities can provide useful data-driven and evidence-based services related to participant goals including goal management, goal feedback, goal reconciliation, goal optimization services, or other services that aid a participant in achieving a positive outcome or desired goal. For example, by helping even young participants (e.g., newly hired employees newly entering the workforce) outline and achieve desired goals across complex areas like legacy planning, retirement, societal improvement, or other goals, the entity will not only enrich the lives of each engaged participants but of society itself.

Thus, the systems and methods of the inventive subject matter can serve to encompass the entire adult lifespan of an individual, from the beginning of adulthood (e.g., turning 18 years old, the start of college, etc.) through mortality.

The entity leverages comprehensive experiences in the form of one or more knowledge databases to establish best-of-breed goal archetypes across “channels” (e.g., financial, health, societal, family, legacy planning, or other services). A participant can select, via one or more computer-based portals, one or more appealing channels and tailor the channel by fine-tuning the channel attributes to meet his or her specific needs. Thus, the individual can optimize and select among these channels to maximize personal achievement (i.e., goals and accomplishments important to them) during their lifetime. Entities having access to participant big data are positioned to utilize the disclosed subject matter to aggregate client data, benefit carrier data, claim data, participant data, or other types of data in unique ways in order to show progress towards participant goals, or to identify opportunities for the participant to pursue new goals.

As discussed herein, entities can acquire participant data across a broad spectrum of demographics or psychographics, including obtaining data from personal area networks. As such data becomes available, possibly from wearable sensors or devices (e.g., instrumented shoes, cell phone telemetry, medical devices, etc.), one or more entities gather the data for analysis and present the data for management by the participants as part of a goal optimization system infrastructure. Further, the system infrastructure provides a service (e.g., SaaS, IaaS, PaaS, Goals as a Service (GaaS), etc.) to intelligent agent technologies that render the information in a consumable fashion for or by the participant. For example, intelligent agents can include those provided by the entity, by third parties, by application program interfaces (APIs), web services, or provided through other avenues.

It is contemplated that the participant using the ecosystem can access the ecosystem via an establishment of an account. It is further contemplated that while employers can be given access to a participant's account or data included within, the account and goal generation preferably belongs to the participant. As such, when a participant leaves an employer, previous goals associated with prior employers and prior benefits plans or packages can be incorporated seamlessly into new goals associated with new employers, new benefits packages and other differences involved with changing employment.

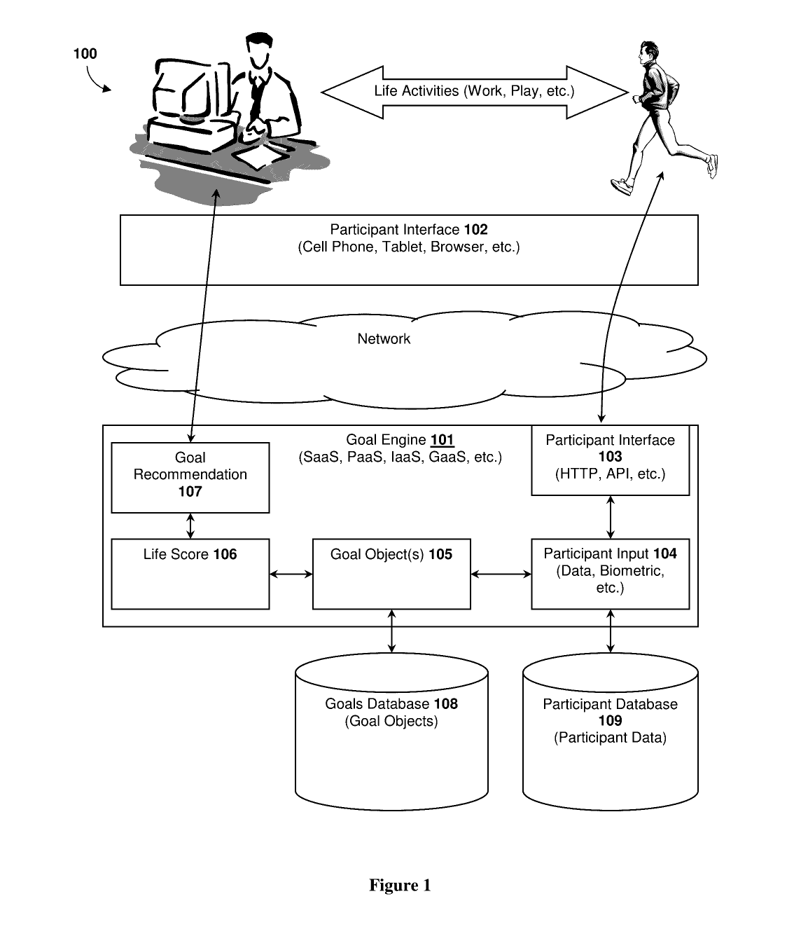

FIG. 1 illustrates an ecosystem 100 where an entity offers a goal optimization service to participants based on the vast amounts of big data. In the example shown, an entity operates a goal engine 101 capable of leveraging vast amounts of data relating to participants and their goals. The participant can interface to the services via one or more participant interfaces 102. In embodiments, the participant can access the goal engine 101 to create one or more goal objects 105 based on their input 104. For example, the goal engine 101 can construct a browser-based web portal that allows the participant to select one or more goal templates that they can populate with desired goal objectives. In addition to or alternatively, the participant can submit participant data during life activities from their personal area network via a cell phone operating as a participant interface.

The goal engine 101 can be embodied as computer-executable instructions stored on one or more non-transitory computer-readable storage media (e.g., hard drives, RAM, ROM, optical media, flash drives, etc.) that, when executed by one or more processors, cause the one or more processor to execute the described functions and processes of the associated subject matters. In embodiments, the goal engine 101 can comprise computing hardware (e.g., one or more processors) specially programmed (e.g. via hard-coded instructions) to perform the processes and methods of the inventive subject matter.

Participant interfaces 102 can include devices such as desktop computers, laptop computers, tablets, smartphones, smart wearable devices, sensors (e.g., biometric, temperature, image, audio, etc.), web-portals or client-side applications accessible via one or more of these devices, and can the devices can include input and output components that allow the users to enter data into the system and receive data ouput from the system (e.g., keyboard, mouse, touchscreen, display screen, microphones, stylus inputs, audio outputs, etc.).

Goal database 108 and participant database 109 can be embodied one or more non-transitory computer-readable storage media configured to store various data components as described herein, which can be accessed by the goal engine 101 via data exchange protocols and techniques to send and receive data.

The participant interface 103 on the goal engine 101 side can be considered to be the protocols, techniques, program instructions, applications and other server- or engine-side communication components enabling the participant interfaces 102 to exchange data to and from the goal engine 101 for the purposes of executing methods and processes associated with the inventive subject matter. The data exchanges can be made through any data exchange network currently known or heretofore devised.

Goal templates can include entry fields that allow the user to enter data associated with a desired goal. Data provided by a user can include a goal category or channel, a goal timeframe, a goal priority, etc. In embodiments, the goal templates can be configured to request additional data based on the initial data provided. The requests for additional data can be based on the selection of an option among several available options (e.g., via a drop-down menu or presentation of alternatives), based on particular words or phrases used by the participant in entering their data, based on goal timeframes or priorities, etc. For example, if a user desires to create a goal in the “retirement” channel, the selection of the “retirement” channel can then trigger the participant interface to retrieve input requests for data associated with retirement goals (e.g., current income, current benefit/retirement plan information, etc.). Goal templates and goal objects can be stored on goal database 108.

When a participant initially interacts with the system, the participant interface can prompt the participant to set up an initial set of goals in one or more channels. To keep the initial intake simple and manageable for the uninitiated participant, the system can prompt the user to set up a limited amount of goals per channel and/or a limited amount of goals overall. For example, the participant can be asked to provide information related to three goals in the “finance” channel.

The participant data that flows through the goal engine can be stored within the participant database 109. One should appreciate that participant data can include information spread across large numbers of participants, possibly including millions of users across many different affiliations. Further the participant data can capture a broad spectrum of data modalities reflecting the activities or life of the participants including biometric data, insurance data, life choices, or other types of data. In some embodiments, the goal engine can sanitize the data for consumption by others, assuming proper authentication or authorization, to protect the privacy of the participant.

The goal optimization system can be used by a participant to plan and balance their goals across the multiple areas of their life.

Via the participant interface, the participant can set goals across the various areas of their lives. The system can, via the participant interface, present a set of pre-defined “life channels” representing the categories or areas of life for which a participant can set one or more goals. “Life channels” can include categories such as retirement, property, health, family, career, philanthropy, legacy, leisure, etc. The life channels can be grouped into broader categories, such as “financial channels” and “non-financial channels”, representing the financial and non-financial aspects of a person's life. The financial channels can be channels for which a financial condition or state is the goal or the primary motivator for a goal. For example, financial channels can typically include goals associated with retirement, legacy, career, and property. Likewise, non-financial channels can be considered to be those that represent goals or motivators independent that are not financial. Thus, for example, non-financial channels can include goals associated with family, philanthropy, health, and leisure. It is understood some channels may extend across more than one broad channel category as the goals associated with the channel will have financial and non-financial aspects to them.

A financial goal can have non-financial aspects and considerations and vice-versa. For example, philanthropy can be considered non-financial because it can involve goals associated with donating time towards a particular cause. However, philanthropy can also take the form of donating financial resources, and thus have financial considerations or goals associated with it. Similarly, a leisure goal can be considered non-financial because accomplishing the goal is not for financial impact but for the fulfillment, enrichment, and/or enjoyment that it brings to the participant's life. However, leisure goals can have financial aspects in that some leisure goals require a certain amount of financial commitment or cost. Conversely, a financial goal can have non-financial factors. For example, a career goal can be considered financial in terms of a goal to have a certain income by a certain time in a participant's career. However, the career goal can also include non-financial aspects such as a professional prestige associated with career status or advancement.

In embodiments the participant data intake can include providing a series of questions whose possible answers are mapped to values from other participants' answers, such that for a given goal the goal engine 101 can ascertain a generalized the starting point for the purposes of score calculations. For example, a series of questions can have a history of participants' answers, whereby the answers are correlated to their eventual goal objects, including the goal object attributes of the goal objects. In a variation of the examples, the collection of historical answers can be statistically grouped into ranges or possible answers for a given question, and the participant's answer can then be correlated to the range that is a best fit for the answer, after which the starting point for score calculations is provided (e.g., initial goal attributes, values, etc.). In another variation of the example, the questions can have multiple choice or other limited-set answer possibilities, whereby historical participants' answers for each option are correlated to a statistical grouping of goal objects or goal attributes belonging to those historical participants that selected that option for the multiple choice answer.

After the initial setup, the goal engine 101 can apply a “game plan” approach to encourage the user to add additional goals across the various channels. The game plan can be based on a default game plan template that can have rules associated with prompting the participant to add or modify their goals and when to do so. The game plan approach can be presented to the participant during the initial set up such that the user can provide input as to when they'd like to be prompted, how fast to be able to add additional goals, etc., such that the learning curve associated with participant interactions with the system can be tailored to each participant's individual comfort level.

As a participant creates or modifies goals, such as via the goal templates or via other goal generation or modification techniques, it is contemplated that the participant can set ranges for the goals associated with prioritizing goals within a channel or across all channels. For example, a range for a particular goal can be associated with a priority of the goal such that a particular goal never falls below a certain priority level for the user. In another example, the ranges can be acceptable ranges of variation within goal attributes prior to initializing an alert or other action (e.g., deactivation of related goals or dependent goals).

In embodiments, the system can support a modification of a goal attribute of a goal with another. For example, for a goal associated with stress reduction, the participant can swap one value (e.g., time off) with another value (e.g., work time) and see the effects of this swapped value.

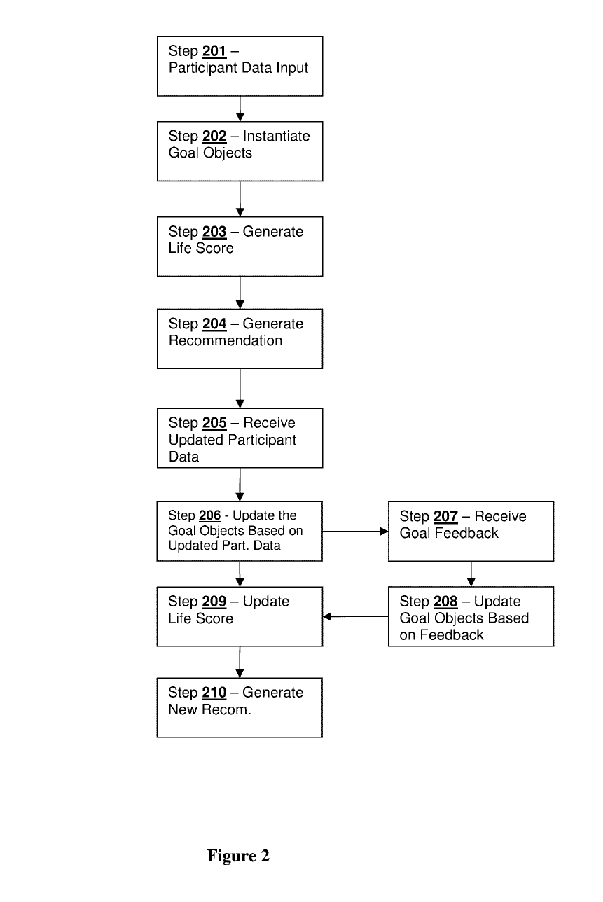

FIG. 2 provides an overview of an execution of methods and processes associated with the inventive subject matter.

At step 201, the goal engine 101 receives the participant's information 104 for one or more participant goals as described herein, such as via goal templates presented via the participant interface 102, as well as gathered through other sources such as via biometric sensors, other electronic accounts (e.g. medical accounts, financial accounts, social media accounts, benefits accounts), employer databases, and other sources of participant data. In embodiments, the participant can be asked to approve the retrieval of data from various sources. Also at step 201, the participant can select the goals they desire to manage, such as by selecting specific goals, categories of goals and/or channels of goals. The participant data received can be considered to be a plurality of participant attributes, representative of various aspects of the participant's life.

At step 202, the goal engine 101 can instantiate one or more goal objects 105 based on the received participant attributes. In embodiments, the goal objects 105 can be instantiated based on the goal templates according to the selected goals, goal category, and/or goal channel. Instantiated goal objects 105 can be embodied as data objects having goal attributes corresponding to the characteristics of the goal represented by the corresponding goal object 105. Thus, the goal attributes can be particular to a goal object based on the goal category and/or goal channel.

The goal attributes, including goal input types, goal data types, goal logic (e.g., rules/algorithms), goal condition rules, and other goal attribute categories used to instantiate the goal objects 105 can be stored in goals database 108, and retrieved according to the goal being instantiated (via the goal or objective, the goal channel, and/or goal category) based on the participant attributes.

Goal objects 105 reflect one or more objectives related to the participant. The goal engine 101 treats goal objects 105 as an evolving, persistent object that can have a duration over extended periods of time (e.g., weeks, years, decades, generations, etc.). As participant data flows through the goal engine 101, the goal engine 101 can maintain, update, modify, or otherwise manage the goal object 105. For example, a goal object 105 might reflect saving for a college fund for the participant's great grandchildren that are yet to be born. As the participant saves money, the goal engine 101 can provide an indication of the progress toward establishing viability of such a college fund.

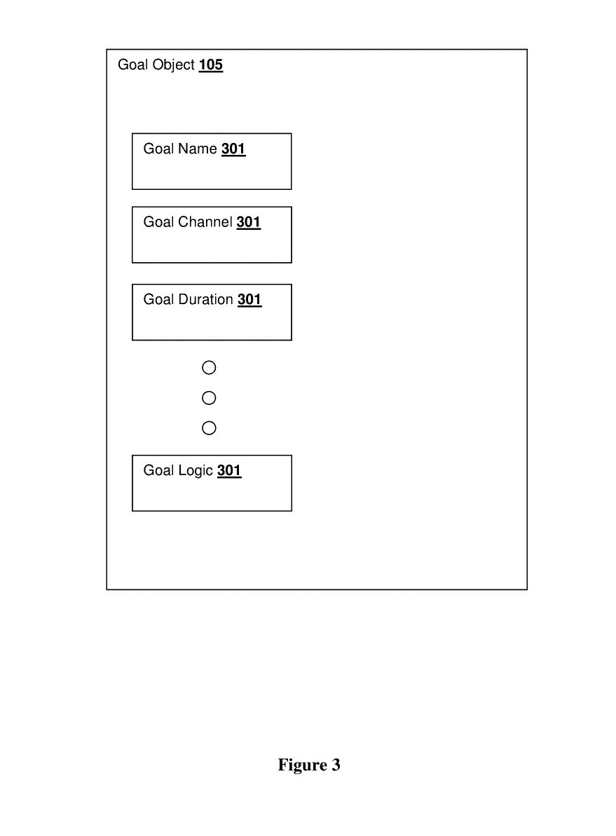

FIG. 3 provides an illustrative example of a goal object 105 having goal attributes 301. The goal attributes 301 can be considered to be the characteristics or parameters associated with the goal represented by the goal object 105.

Examples of goal attributes 301 (some of which are illustrated in FIG. 3) can include a goal name, a goal channel (e.g., the highest level classification of goals), a goal category (e.g., a subset category of a channel), a goal duration (e.g., time to complete the goal, estimated or actual end date for goal whether completed or not; can be a null value for persistent goals without a set end date), goal conditions (e.g., the rules or conditions that dictate a goal completion based on inputs to a goal, and that allow for the tracking of a status of the goal towards completion, can be considered to be the desired outcome of the goal), goal logic (e.g., the rules, algorithms and/or processing instructions that are used by the goal engine 101 to process a goal), goal status (e.g., percentage of completion or other numerical indicator of progress, can also include non-numerical indicators such as “on track”, “exceeding expectations”, “lagging behind”, “at risk”, etc.), goal inputs (e.g., identification of the data inputs used in determining the participant's progress towards the goal, including the participant's data and other data sources), goal data (e.g., the data used to measure and calculate the progress of the goal and can include historical data accumulated over time), goal priority (e.g., a priority of the goal relative to other goals, a goal update (e.g., when the goal was last updated), a goal type (e.g., a life goal versus a tempus goal), goal outputs (e.g., the data types that are output by the goal and can be used as input data to other goals).

Goal logic can be considered to be the rules, algorithms, and/or processing instructions used by the goal engine 101 to use the input data to a goal and calculate goal status, goal outputs, and other data associated with the progress of a goal. The goal logic of a goal will be associated with the purpose of the goal itself. In other words, the nature of the goal represented by the goal object will dictate the goal logic to be used.

For example, for goals associated with retirement planning, the goal logic can include actuarial algorithms such that given the input data, the goal logic can project a retirement plan goal and track its progress.

For a family goal, goal logic for this goal can include algorithms that can add the time spent together as a family, track locations visited together and activities performed together. Additionally, goal logic for this goal can include inferring, by the goal engine 101 via inference rules, a satisfaction level based on the data gathered via social networking, emails to/from the family members, survey responses, etc.

For personal goals, goal logic can include algorithms that can aggregate an amount of time spent pursuing the goal, and determine a quality of the time spent based on participant feedback, social media or email commentary on the goal to friends, family, acquaintances, and by monitoring biometric signals and other indicators of a more relaxed, more pleasant, and/or less stressed demeanor for a time period following the time spent pursuing the personal goal. The algorithms can include, for example, inference rules to correlate and infer meaning from messages via keywords, language use, style, etc., and statistical analysis of biometric sensor data against historical data for that participant to determine a measurable effect of pursuing the personal goal.

In embodiments, goal logic attributes can include the logic (e.g., algorithms, rules, etc.) itself such that the goal engine 101 can incorporate the logic straight from the goal object 105. In embodiments, the goal logic attributes can include identifiers of the applicable algorithms, rules, etc., that can be stored in a logic database, such that the goal engine 101 can retrieve the appropriate logic from the logic database for execution.

In embodiments, the participant data received can be historical data for the participant as related to the goal, and the goal logic, goal conditions, and other goal attributes adjusted based on an analysis of the participant's past behavior so that the goal logic associated with interpreting input data and calculating goal progress can more accurately reflect how the various attributes associated with the goal actually affect the participant. For example, historical data regarding a participant's training or exercise habits and performance gains can be used to more accurately model the current effects of exercise on the participant's health. Likewise, an analysis of the effects of work or stress on the participant's demeanor, interaction with others, ability to function, energy level, biometric levels, etc., can allow the goal engine 101 to adjust the goal logic and goal attributes associated with a goal object 105 of stress management by identifying the factors of daily life that have historically caused the most stress, and also helped relieve it the best. This analysis of participant's historical data can be performed via statistical analysis of data points associated with a desired goal (e.g., clustering analysis, principal component analysis, multivariate analysis, and/or other statistical algorithms).

Goal priority can be a priority of the goal object 105 representative of the importance of the goal in the participant's life relative to other goals. The goal priority can be user-designated and user-modified, as discussed herein, such that participants can re-arrange the priority of their goal objects 105 to reflect the changing priorities in their lives. The goal priority can include one or more of a global priority (e.g., among all goal objects 105 for a participant), a channel priority (e.g., among all goal objects within that channel), a temporal priority (e.g., a priority adjusted according to the importance of a goal at a particular time and/or for a particular duration), and a chronological priority (e.g., associated with completing or addressing a particular goal first before another goal).

In an illustrative example, a goal object 105 associated with a participant's financial goal of retirement can include:

A goal category of “Finance—Retirement”, indicating that the goal is within the finance channel, and directed to retirement.

A goal duration of a retirement date as a future date.

A goal condition of having a certain amount of retirement benefits accumulated by the retirement date. The goal condition can include an amount such that it is possible to have a certain amount or level of income or financial resources available for a projected duration of post-retirement life (e.g., and to live for a particular amount of years based on actuarial mortality tables or other estimates).

Goal inputs can include data inputs associated with calculating a projection of a participant's retirement. These can include the income and expenses in the participant's life, which can include data associated with current actual income and expenses (e.g. debts, periodic expenses), current benefit plans and contributions thereto, as well as projected income and expenses in the future due to factors like inflation, projected expected income for the participant, etc. The goal data for the goal object 105 of this example is the data corresponding to the goal inputs used for the goal object, which can include historical data and as well as current data as it is received. Thus the goal data can include data associated with past income and expenses, a current accumulated contribution to benefits, etc.

Goal logic associated with the retirement goal object 105 can generally include the necessary rules and algorithms used to determine a projected retirement for a participant. For example, goal logic can include the rules and algorithms used to project the retirement benefits by taking into account the retirement benefit plan, the contributions to the plan by the participant, the expected retirement date, the desired post-retirement income, such as via actuarial techniques incorporating projection tables, mortality tables.

In another example, a goal object 105 associated with the “family” channel can represent a desire to maintain and continue to cultivate a relationship with a spouse. Goal attributes associated with this can include goal inputs and goal data associated with time spent together, locations visited together (e.g., gathered via check-ins from social networking sites), quality of time spent together, etc. Goal inputs can also include importing data from the spouse's corresponding goal objects, or from social network sites or other sources of data associated with the spouse. Goal logic for this goal can include comparing the time spent and the number of “dates” together over a period of time with the statistics of time spent and dates of a sample size of couples, etc. and their relative states of their relationships as a function of the time spent, dates, and other quantifiable aspects of their relationship. Additionally, goal logic for this goal can include inferring, by the goal engine 101 via inference rules, a spouse's satisfaction level based on the data gathered via social networking, emails to the spouse, etc. Goal conditions associated with this example can include meeting subjective expectations set by the participant, and/or by their spouse related to a comparative state relative to a population and/or a sustained satisfaction level.

In a further example, a goal object 105 associated with a health channel can include goal inputs and goal data from biometric sensors (e.g., blood monitors, heart rate monitors, GPS monitors to track running, sleep monitors, stress monitors, etc.), caloric intake data, participant weight data, body-mass index data, respiratory data and other health-related data. Goal logic can include logic associated with determining a participant's condition based on the data received, including logic associated with a change in a physical condition. Suitable logic can include algorithms and calculations used to determine health and medical status and conditions (e.g., those recognized by authoritative or regulatory organizations). Goal conditions can include reaching a particular weight, reaching a particular cholesterol level, being able to hit exercise milestones (e.g., running 5 miles every other day while maintaining a target heart rate within a desired range, etc.).

In embodiments, goal objects can represent future goals that the participant is not yet ready to engage. These goals can be considered “delayed” or “dormant” goals that can correspond to a particular period in a participant's life, or can correspond to goals that a user is only able to pursue under the right conditions. The goal objects corresponding to dormant goals can lay dormant until becoming active. Dormant goals can therefore include goal attributes associated with trigger conditions that cause the goals to become active in the participant's goal management environment. Examples of trigger attributes can include a length of time from goal creation, a date, a time duration or date associated with a particular event, an occurrence of an event, a completion or failure of another goal, crossing a threshold associated with a participant attribute, crossing a threshold associated with one or more goal attributes of the dormant goal, and crossing a threshold associated with one or more goal attributes of one or more other goals. In one example, dormant goals associated with a participant's child, can correspond to future stages of the child's life. In this example, a dormant goal to begin selecting a minivan can be dormant having a trigger of three months from the child's birth, until the child passes the so-called “diaper shock” stage for new parents and holding acting on the goal off until the parents are able to get a bit more sleep. In another example, a philanthropic goal of donating to a charity can be contingent on a participant maintaining a balance in a bank account of more than $50,000. If the goal object for the philanthropic goal was created at a time when the participant did not yet have the $50,000, then the goal object remains dormant until the participant's account exceeds the $50,000 mark. Additionally, goal objects that are active can go dormant if the threshold is crossed back. Thus, in this example, if the participant's bank account balance drops below $50,000, the goal goes dormant until the amount once again exceeds the $50,000.

Goal objects corresponding to dormant goals can be generated based on a user-initiated goal creation request, an occurrence and/or can be generated by goal engine 101 based on other goals associated with the user. In the example of the newborn child above, the event of having a child can trigger the creation of a set of default dormant goals typically associated with the phases of a child's life (e.g., goals associated with saving for college, goals associated with social, emotional and intellectual child development, etc.).

In embodiments, the goal engine 101 can be configured to recognize “life events” in a participant's life that can affect the participant's abilities to achieve goals. Based on the life event, the goal engine 101 can generate recommendations regarding adjusting priorities and/or overall goals. The life events thus act as a trigger to the goal engine 101 that a participant's life has likely been substantially altered or changed, and that a change in goals and/or priorities may be necessary to adjust. Life events can be events that directly involve or happen to the participant. Examples of “personal” life events can include a change in marital status, a graduation, the birth of a child, a death in the family, becoming unemployed, becoming employed, changing employers, a medical emergency, a loss of property (e.g., due to a natural disaster, theft, accident or other cause of loss), etc. Life events can also include events that do not directly involve the participant but that can nevertheless affect the participant's goals and priorities. For example, these “indirect” life events can include large fluctuations in the stock market (e.g., affecting the participant's investments, affecting an industry in which the participant is employed, etc.), changes in laws (e.g., changes in tax laws that affect the participant's take-home income, affect retirement, etc.), large fluctuations in prices of goods/services, events occurring in locations associated with a participant's goals (e.g., a conflict erupting in a region that a participant wished to travel to, a closure of an amusement park that was a destination of a cross-country family road trip, a city being awarded international competition events during a projected visit), etc.

To recognize life events, the goal engine 101 can reference incoming data against a listing or other index of known, applicable life events to the participant's goals. The data used to detect a life event can be received via the various data sources indicated herein. For example, the participant can enter the life event of having a child as participant input 104 via the participant interface 102. Other life events can be recognized via information received about the participant from other sources. For example, a submission of a birth certificate of a child from a government agency (with the participant's authorization to obtain such records), the updating of employee benefits at the participant's employer, tax return information, etc. Additionally, the system can receive data from external sources such as news sources, market sources, and other reporting services and detect news, market or other reported events as applicable life events using searching techniques, matching techniques, inference techniques and other such recognition techniques.

Life events known to the goal engine 101 can include a default list of life events that can be considered applicable independent of a participant's goal objects, such that they can change a participant's goals or priorities regardless of what the participant's goals or priorities may be. For example, the birth of a child can be considered to be a significant event in a participant's life even if it is not a participant's stated goal (and thus, not represented via a goal object 105). Additionally, the life events can include life events specifically associated with one or more of the participant's goals or priorities. For example, these can be life events that render a particular goal moot.

The life events can be embodied in the form of life event objects having associated life event attributes.

In embodiments, goal objects 105 can be categorized as “life goal objects” or “tempus goal objects.” Life goal objects can be considered “primary goals”, which can represent long-term life goals (e.g., goals having durations lasting years or decades) or persistent goals that do not have an end date. For example, a goal object can be considered a life goal object if the duration is longer than a year, 5 years, 10 years, or longer. Long-term life goals can include retirement goals, child college education goals, paying off a mortgage, achieve a certain level or stature in a career or within an organization, reach a certain mastery of an activity, write a book, etc. Persistent goals can be considered to be goals that require maintaining a particular state, status or level of goal satisfaction. Examples of persistent goals can include maintaining a certain relationship level with a family member, maintaining a particular credit rating, maintaining a certain level of health or physical fitness, staying current with a topic of interest, etc. These types of persistent goals are never fully finished, but instead are directed towards maintaining a particular aspect of the participant's life to a desired level or measure of quality. Another type of persistent or long-term life goal objects can represent goals with a finishing condition but without a set time duration. These can be representative of life goals that a participant simply hopes to accomplish before during their lifetime. Examples can include a legacy goal of leaving a certain amount of inheritance for a spouse and children, a goal to travel to a particular destination at least once in a lifetime, a personal goal to learn a new language, etc. In a variation, these goals can have a duration of an expected longevity such as determined according to longevity tables and/or participant health data. In embodiments, a goal represented by a goal object can be considered a “life goal” based on an overall priority to the participant, regardless of the goal duration. For example, a set of goal objects 105 representative of the highest-priority goals according to an overall priority (e.g., the top 3 or 5 goals) can be considered life goal objects.

In contrast to life goal objects, tempus goal objects can be considered to be short-term or temporary goals, or sub-goals associated with progressing towards the completion of other goals (e.g., life goals or ‘higher-order’ tempus goals in a hierarchy). For example, for a retirement goal object, tempus goal objects can represent goals to contribute a particular amount to retirement savings or benefits every paycheck, month or year. In another example, a life goal to achieve and maintain a particular level of health or physical fitness can include tempus goals to exercise for a particular amount of time several days a week, to run a certain number of miles in a week, etc. In a further variation this example, a tempus goal for the overall fitness life goal can include running a 10K race every two months, and a tempus sub-goal (which is a tempus goal of a lower hierarchy) of the 10K tempus goal can include a goal to run a certain amount of days a week for a particular period of time leading up to the race to get into and/or maintain a proper running fitness level.

Tempus goal objects can be generated based on life goal objects, such as the objectives of the life goal, the duration of the goal, and the participant's current state relative to the goal, as represented by attributes of the life goal object and/or participant attribute data.

Goal objects 105 can be correlated or linked via one or more of their corresponding attributes. The link can be via correlation rules or subroutines that govern the nature of the relationship between the goal objects, and/or the corresponding correlated goal attributes of the respective objects. In one aspect of correlated goal objects, a goal attribute of a first goal object 105 can be an output attribute that can also serve as an input attribute to a second goal object 105. The correlation can include algorithms or processing rules executed by the goal engine 101 such that the effect of the output attribute is correctly applied as an input attribute. In an example, the goal engine 101 can access link subroutines that can create links based on goal attributes associated with influential factors of a participant's life. The link subroutines can create correlations between goal attributes associated with one or more of “time”, “money”, “productivity”, “efficiency”, “happiness”, and “energy.” The goal attributes associated with each of these factors can be considered to be goal attributes that can affect or can be affected by these factors. The resulting link can be a input-output link (wherein one goal attribute is an output attribute providing an input to another goal attribute in a different goal object 105) and/or a combination link, where the linking of the goal attributes can contribute to an enhanced effect of each goal attribute on each respective goal object and, ultimately, on the life score. The combination effect can be a constructive or destructive effect. The pairing factors can be considered to be metadata for a particular goal attribute that can describe which of the factors can apply and how. For example, a goal attribute associated with “money” can be linked such that a complete picture of a participant's financial state can be made based on all of the participant's goals. Thus, this can involve goal attributes of finance goals (e.g., investment amounts, income, contribution levels, etc.) linked to money-related goal attributes of non-finance goals (e.g., for a personal goal object associated with the goal of practicing a particular hobby, a goal attribute can include the cost to practice the hobby). Mortality or other benefits-related goal attributes that can vary with a participant's health status can be associated with the “health” factor, such that they are linked to output factors of health-related goals (e.g., such that improvements in health status can be reflected in estimated costs for benefits, insurance coverage, etc.).

In an illustrative example, consider a goal object 105 associated with a participant's goal for retirement at a certain age (i.e., a “retirement object”). As part of the retirement object, a goal attribute includes a mortality assumption and a contribution amount that the participant has to pay into the retirement plan. Ordinarily, contribution and benefit levels are based on actuarial tables for a population of the participant's age. Further, because actuarial tables are for a population, the tables and values therein are static. Thus, in traditional actuarial practice, the participant's mortality does not take into account the participant's actual state (e.g., their health, fitness level, etc.). In this example, however, a goal object 105 associated with a goal to get in shape (i.e., a “fitness object”) has an output attribute of a current fitness level of the participant. A link can exist between the mortality assumption of the retirement object and the current fitness level of the fitness object, including algorithms that can correlate a fitness level to an estimated increased in lifespan. The algorithms can be based on medical estimates, studies and general practices shown to establish correlations between a health level and an extended lifespan. In embodiments, the algorithms can simply aggregate estimated reductions in various risks to extended life as suggested by medical studies (e.g., medical studies showing that a person being X % overweight is at a Y % risk of heart disease, etc.) or other correlations. Having established the correlation, the retirement object can recalculate one or more of the goal attributes associated with the goal object. For example, an increase in the health/fitness level output by the fitness object that correlates to an extended lifespan (and thus, a shift in mortality assumptions for the participant) can result in an adjustment in the necessary contributions to maintain the retirement date, a reduction in a retirement date (i.e., an earlier retirement), a greater benefit amount upon retirement, etc.

A detailed example of a method of executing the fluid mortality table calculations according to embodiments of the inventive subject matter can be found below.

In embodiments, the goal engine 101 can derive a participant state for that goal prior to instantiating the goal object 105 for the goal. The participant state can comprise the participant attributes and other data used in the instantiation of the goal object 105 prior to any normalization, transformation, standardization or other processing in preparation for use in instantiating the goal object 105. The participant state can give a “raw” snapshot of the current state of the participant prior to applying their current status data towards the analysis of their goals.

At step 203, the goal engine 101 can generate a life score 106 for the participant based on the instantiated goal objects 105. The participant's life score can be considered to be a score reflecting a degree of balance or optimization of a person's current state relative to their goals. In embodiments, the life score can be associated with a likelihood of completing one or more of the goals represented by goal objects 105. In embodiments, the life score can be associated with a likelihood of completing one or more of the goals represented by goal object(s) 105. The life score can be generated as a single score or value that can be presented to the participant.

In embodiments, the life score can be generated based on a plurality of goal objects associated with the participant and the participant's progress towards those goals, such that the life score represents a measure of a balance of the efforts of the participant towards meeting those goals.

In embodiments, the life score can be generated as a function of a calculated likelihood of success of each goal based on a comparison of the goal attributes of a participant with those of other participants. Many factors can come to bear against determining a likelihood of success with respect to an individual goal object 105. In an example, a heart rate of a participant could influence the likelihood of success of the college fund because it indicates that the participant's life expectancy has increased, which gives rise to more revenue generating work lifespan that results in additional money saved. Thus, participant data can have a direct impact on objectives (e.g., money saved) or an indirect impact on objects (e.g., derived or correlated relationship). Further, external factors beyond participant data can influence the likelihood of success. In the case of long range objectives (e.g., years out, decades out, generations out, etc.), factors such as expected inflation rate or societal unrest could impact a likelihood of a success because such factors could alter how the future value of the money saved or how the great grandchild might access their money in the future.

The likelihood can be determined through various techniques. In some embodiments, the goal engine compares success of other participants having similar attributes or characteristics to that of the target participant with respect to succeeding at similar goals. In view that the databases can store thousands, millions, or more points of information, the likelihood can be derived based on historical statistics, possibly influenced based on external factors as alluded to above. All possible calculations of likelihood are contemplated.

In embodiments, the life score can be an average of the calculated likelihoods of the goal objects. In other embodiments, the life score can be an aggregation of the calculated likelihoods.

In generating a life score, the relative contributions of each goal object to the life score can be weighted according to the priority of each goal object. Thus, the likelihoods associated with high-priority goals influence the life score to a greater degree than lower-priority goals having lower weights.

In embodiments, the goal engine 101 can generate a plurality of recommendations for a life score taking a systematic or iterative approach, such as by emphasizing certain goal objects 105 via a modifying the weighting of goal objects and/or goal attributes. Having the various permutations, the goal engine 101 can then select the recommendation that optimizes the balance between the participant's goals and therefore maximizes the life score. This approach can also be taken to applying hypothetical changes to a participant's status (e.g., such as by implementing changes to status that can be in line with possible recommendations or outside of possible recommendations) and then update a life score to generate a hypothetical life score. This can enable a user to visualize, in real time, predicted outcomes of taking certain actions according to various goals.

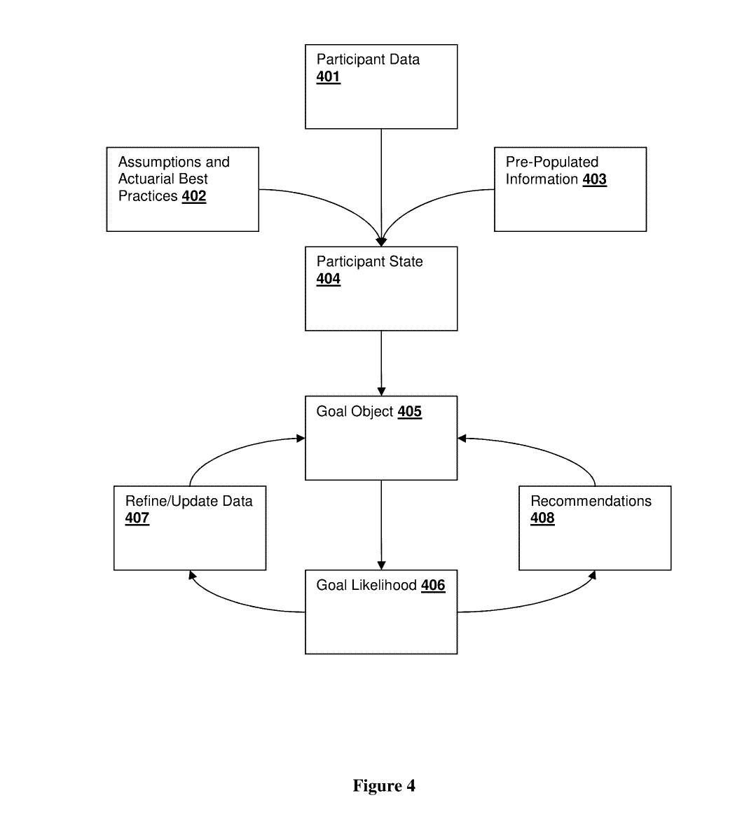

FIG. 4 provides an illustrative example of a calculation of a likelihood of success for a retirement goal object.

In the example of FIG. 4, the participant state 404 associated with a retirement goal is determined based on participant input data 401 (e.g., the data provided by the participant, either directly or via access to their relevant accounts), assumptions and actuarial best practices 402 (e.g., market data and market-driven assumptions, which can be updated in real-time), and pre-populated information 403. The pre-populated information 403 can be average data (such as across other similar participants or segments of a population) to compensate for missing participant input data 401. In embodiments, it is preferable to keep the required input data from the participant simple such that the process of initiating the goal management is intuitive and easy to use. In these embodiments, pre-populated information 403 can be used in place of participant data that is not requested. This data can be requested at a later time by the goal engine 101 or can be edited by the participant as desired.

Having generated the participant state 404, the goal object 405 can be instantiated for the retirement plan based on the participant state data and calculations associated with retirement goal planning. In the illustrative example, it is contemplated that the calculations can be based on stochastic simulations involving a large number of scenarios (i.e., 500 or more). Additional details regarding these calculations are provided below.

The goal likelihood 406 is then calculated as a function of the goal object 405 by comparing the attributes of a goal object 405 with attributes of goal objects of other members. The comparison can be performed via statistical algorithms (e.g., clustering, nearest neighbor, means-squared, etc.) that can give the relative standing of the participant relative to a reference population.

The goal likelihood 406 can preferably then be incorporated into the generation of a life score for the participant based on the goal object 405 and the goal likelihoods of other goal objects.

As updated/refined data 407 is received, the goal engine 101 can update the appropriate goal attributes of goal object 405 and re-calculate the goal likelihood 406 (and consequently, the participant's life score).

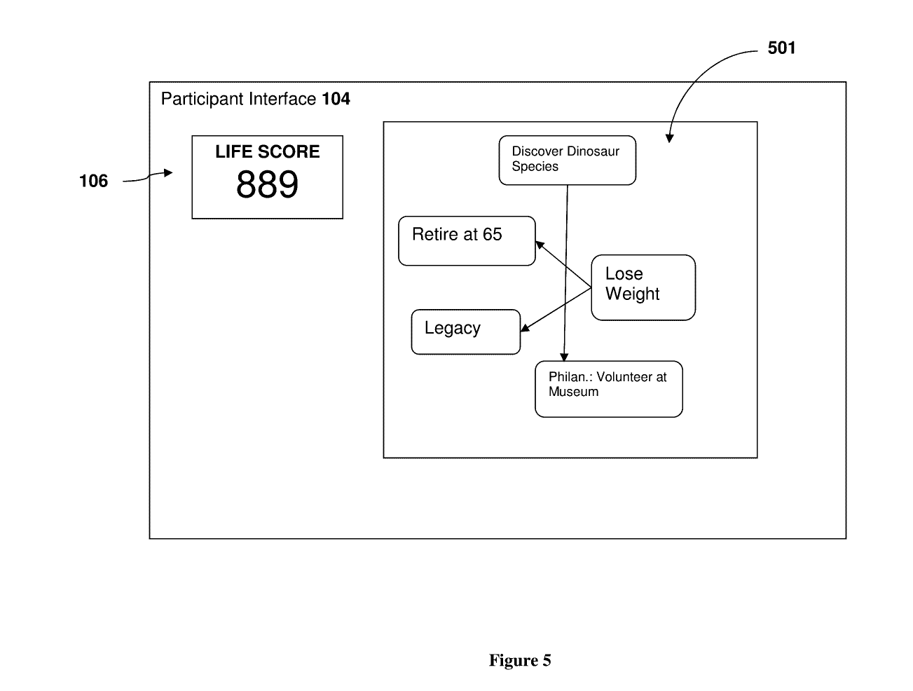

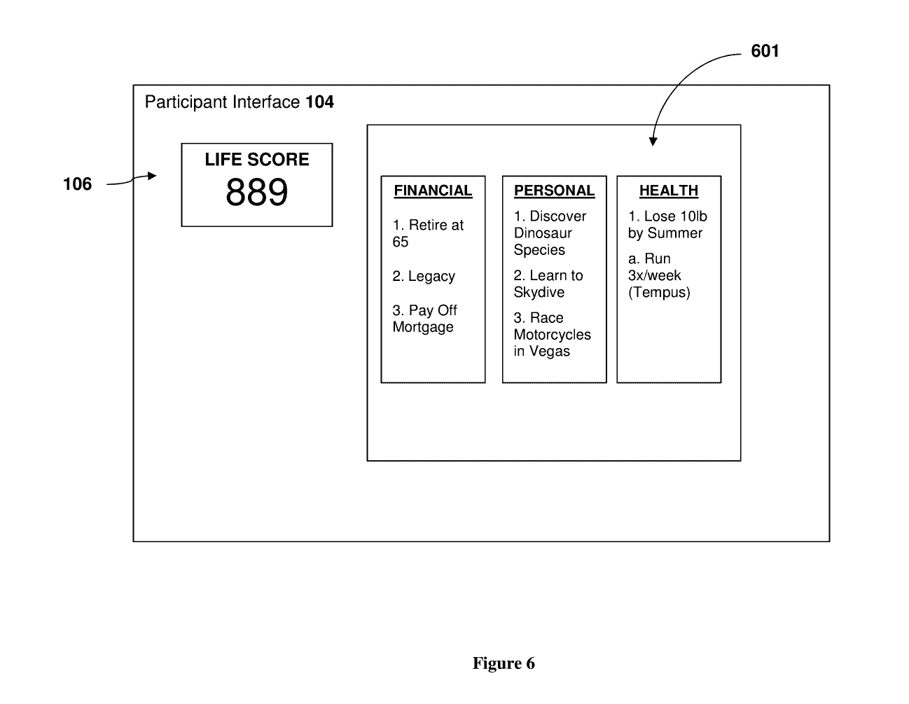

FIGS. 5-6 provide illustrative examples of a user-facing portal presented via participant interface 104 providing a participant's life score 106. FIGS. 5-6 also show alternative displays 501,601 showing a participant's goals represented by goal objects 105. In the example of FIG. 5, the goals are visualized according to the boxes, arranged according to their priority attributes. In the example of FIG. 5, the participant's highest-priority goal is to “discover dinosaur species”, and the rest of the goals moving downward represent a descending priority. Also shown in the example of FIG. 5 are links between goals, illustrated via the arrows. As shown in FIG. 5, the “discover dinosaur species” goal is linked to a philanthropic goal of “volunteering at a museum”. The link between these goals can represent that progress towards of the “discover dinosaur species” (e.g., attributes associated with research into possible dig sites, keeping current with digging techniques to maximize success, etc.) can also benefit the goal of volunteering at a museum because the participant will be more knowledgeable about these topics and, as such, the time spent volunteering has more value and is more meaningful to the philanthropic goal. Thus, the contributions of both linked goals to the life score is enhanced. Likewise, the “lose weight” goal is shown as linked to the “retire at 65” goal and the “legacy” goal, such that progress towards the “lose weight” goal also works towards the “retire at 65” goal (as illustrated in the example above) and the “legacy” goal. The example of FIG. 5 shows the top ranked goals across all channels. The goals can show the channel to which they are associated (as shown in the “Philanthropic: Volunteer at Museum” goal) or lack any such markings (as shown in the other goals).

FIG. 6 shows a variation of the presentation 601 of the goals. In FIG. 6, the goals are presented according to their corresponding channels. Here, more goals are shown than in FIG. 5, as the goals and rankings can be presented in list form and can be channel-specific. Also, the use of textual listings in this case allows for more information to fit in a more straight-forward (but less visually appealing) presentation. Also shown in FIG. 6 is that a goal can include more information than in FIG. 5. For example, the health-related goal is simply “lose weight” in FIG. 5, but is presented as “Lose 10 lb by Summer” in FIG. 6. Additionally, a tempus goal associated with the “lose weight” goal is shown. Tempus goals can be shown as sub-categories of “life” goals.

The examples of FIG. 5 and FIG. 6 correspond to the same goal management instance for the participant, showing the same information in different ways. The presentation can be via an application or web portal, and can allow for customization including adding more information to display or removing information, switching between alternative ways of presentation, viewing previously completed and/or failed goals, and other customization options. For example, generated recommendations, relevant offers for services, and other useful information can be presented via the participant interface 104. The priority of the goals can be user-adjusted in the interface examples of FIGS. 5 and 6. In visual displays such as in FIG. 5, the user can “grab” a goal with a pointer of the interface 104 (e.g., a mouse on a computer, a pressed finger with a touchscreen interface) and drag it up or down relative to the other goals. The reorganized order of goals will correspond to the user-defined visual order from top to bottom of the display. Based on the reorganization, the priority attributes of each goal object can be adjusted accordingly. For the example of FIG. 6, the reorganization can be done with the same “grabbing” of an entry on a list as in FIG. 5, and reorganized within the channel. Alternatively, the number can be highlighted and edited by a user such that the order is reorganized according to the user-provided order.

For each of the goals, additional information can be presented including a progress report for each of the goals according to the goal status attributes for each goal.

In embodiments, the participant can set up rules via the participant interface 104 that configure alerts, which can be sent to their mobile devices or other computing devices when certain goals (e.g., health or financial) are slipping beyond an acceptable threshold or have been achieved. Other configurable alerts could be sent to “coaches” (e.g., specialists in particular fields, experts, designated helpers, etc.) as desired.

The goal engine 101 can be configured to generate one or more recommendations 107 at step 204 based on the generated life score and, optionally, the participant's goal objects 105 (and/or their respective goal likelihoods) that contribute to the life score.

The recommendation 107 can include a suggested action for the participant to take. The recommendations can be channel-specific, or can be recommendations intended to affect goals across multiple channels. Examples of types of recommendations can be to distribute financial resources differently (e.g., adjust expenses, contributions, donations, etc.), to take an action beneficial to the participant's mental, physical and/or emotional health (e.g., exercise to improve physical health, indulge in a hobby to relieve stress, etc.), to take an action to improve a personal relationship, etc. The action in the recommendation can preferably be an action that results in a modification of one or more of the goal attributes of a goal (and thus, helps progress the goal towards successful completion).

In embodiments, the recommendation 107 can include a recommendation of a particular product or service applicable to one or more of the participant's goals. For example, the recommendation can be a benefit plan from an employer selected from various options and plans according to the life goal, and attributes associated with goal objects 105. Because the recommendation 107 can reflect a cross-channel decision making by considering goals across multiple areas of the participant's life, the recommended product or service can be directed at goals in the channels where they are most beneficial. Where a purely financial decision-making might focus on recommending every extra dollar that a participant has be directed to retirement, the cross-channel approach of the inventive subject matter recognizes that people's goals can be multi-faceted, and allows for a recommendation that the extra dollar be used for personal wellness, fulfillment and improvement, such as for a wellness product for the participant.

In embodiments, the recommendation 107 can be an action that is directed towards furthering the goal having the greatest priority. In embodiments, the recommendation can be an action that is directed towards furthering the goal that is closest to successful completion.

In embodiments, the recommendation 107 can be based on a commonality of goal objects or goal attributes among the objects affected or needing improvement.

In embodiments, the recommendation 107 can be generated as a function of the life score and one or more attributes from one or more of the goal objects. In these embodiments, the recommendation can be generated based on attributes of a same type across goal objects, such that the action associated with the recommendation affects the greatest number of goal objects. Thus, for a participant having a large amount of goal objects whose goals are affected by attributes reflecting the participant's level of stress (e.g., goals associated with a career, associated with family relationships, health as related to sleep, etc.), the generated recommendation can be one that results in the reduction of stress.

In a variation of these embodiments, the recommendation 107 can be generated as a function of correlated or linked goal attributes from various goal objects 105, such that the effect of the recommendation results in a “snowball” effect down the linked attributes. Using the example from above whereby a health goal can affect a retirement goal by changing the contributions due to a shift in mortality, a further effect can be that the reduced contributions required free up financial resources that can be added to charity or other philanthropic goals. Thus, a suggestion to take actions to improve physical health has a cascade effect through a financial goal associated with retirement, which in turn also furthers a philanthropic goal.

In embodiments, the recommendation 107 can be generated based on the life score and the corresponding goal likelihoods of each goal object 105. Since goal objects 105 can be weighted according to a priority, each goal object 105 will contribute to the calculation of the life score differently. Thus, for a heavily-weighted goal object, a small variation in the goal likelihood (used as part of a calculation of the life score) can have a larger impact on the life score than a larger variation in a goal likelihood of a goal object with a lower priority. To generate the recommendation, the goal engine 101 can first determine the variations of the goal likelihoods with respect to a reference population of other participants having comparable goal objects (corresponding to each of the participant's goal objects 105). The goal engine 101 can then calculate a normalized goal likelihood for each goal object 105 as a function of the variation of each likelihood and the weighting associated with the goal object due to the goal's relative priority. The normalized goal likelihoods for each goal thus represent a variation from a reference population of other participants' goal objects when adjusted for the participant's prioritization. The goal engine 101 can then generate a recommendation targeting the goal objects 101 having the normalized likelihoods most susceptible for improvement (thus giving the greatest improvement to the life score).

In embodiments, the recommendation 107 can be provided to the participant such that the participant has to manually implement the recommendation (e.g., adjust an amount of contribution to a benefit plan, an amount towards a legacy savings goal, schedule an appointment with a friend or family member in furtherance of a personal goal, join a gym, or schedule reminders in a calendar to go running every morning). Alternatively, the goal engine 101 can provide the recommendation 107 such that it requires the participant's approval to implement, but upon approval, the goal engine 101 can implement the recommendations automatically (e.g., upon approval, adjust the contribution to the benefit plan a particular percentage, etc.). In another embodiment, the participant can elect to have the recommendations implemented automatically, either with a notification to a user (but without requiring approval) or without a notification to the user. Thus, the recommendation to exercise to get in a better state of health and lose weight can be presented to the user, but the scheduling of a trainer specializing the type of exercise the user needs, for a particular periodicity, etc., can be set automatically by the engine.

In the example of FIG. 4, a recommendation 408 is shown as being generated based on the goal likelihood 406, but as described herein, it can be generated based on a combination of goal likelihood 406 and the other goal likelihoods of the other goal objects associated with the participant.

The goal engine 101 can utilize the likelihood to derive recommendations on additional course of actions that could augment, enhance, or otherwise alert the likelihood of success. For example, back to the example of establishing a legacy fund for great grandchildren, the engine might recommend jogging every other day because it might extend life expectancy, which raises the earning potential of the participant. Such recommendations might likely be down weighted by counter actions (e.g., not jogging) because jogging every other day might increase the risk of being involved in an accident on the street. Once one or more recommendations are established, the recommended course of action can be presented to the target participant via their interface.

At step 205, the goal engine 101 can receive updated participant data via some or all of the data input sources as the initial participant data. For example, for financial goals, updated data can include updated participant account information, updated market values, updated actuarial table values, etc. In another example, for health goals, the updated data can include updated sensor data associated with periods of activity or exercise including duration and biorhythmic sensor data. The updated participant data can be reflective of a participant following (or not following) a recommendation provided at step 204, and to what degree.

At step 206, the goal engine 101 can update the goal objects 105 as appropriate based on the updated participant data, which can include updating the goal attributes associated with a participant's current state, a goal status and goal priority among others, and consequently update the life score at step 209 based on the updated goal objects 105.

The updates to goal object at step 206 can include a deactivation of the goal object 105, such as due to a completion of the goal, failure to complete a goal, or for a goal becoming inactive as described above. In response to this, the goal object can prompt a participant for and receive response feedback at step 207 on the goal now that the goal is no longer active. This can include questions directed at assessing the accuracy of the goal object relative to the goal the applicant was looking to achieve. For example, a completed personal goal object associated with getting involved with a new hobby for a particular duration of time can include questions associated with whether the hobby was what the participant expected in terms of personal fulfillment, enjoyment, or other purpose that drove the participant to want to set the hobby as a goal in the first place. In other examples, the feedback can be collected by observing the effect of the completed goals (such as tempus goals) on other goals (such as the further progress towards the life goal associated with the tempus goal after the tempus goal's completion). Over time, feedback collected from the user can be used by the goal engine 101 to, at step 208, to calibrate goal objects and goal attributes such as prioritization weighting, generation of tempus goals, “ramping up” of sequential or progressive goals associated with various channels, the generation of future recommendations for particular goals, goal categories, goal channels or associated with goal attributes, and tweaks to calculations of the life score to consider a participant's subjective view of life relative to a reference population ‘generalized’ scoring system. The updates of step 208 can be further used in combination with the updates of goal objects at step 206 to update the life score at step 209.

At step 210, the goal engine 101 can generate new recommendations (or re-generate recommendations remaining relevant) for presentation to the user.

The following is an illustrative example of a use case that can implement the generation of the life score and subsequent generation of a recommendation based on the goal objects and the life score according to one or more of the techniques described herein.

The use case considers a user who has plurality of goals. Among the plurality of goals is a career goal associated with career advancement, a tempus goal for the current year associated with a goal condition of a production goal for his job, as sub-goal of the career goal and where the completion of the tempus goal directly inputs into a determination of likelihood of career advancement. The goal condition of the tempus goal is a production goal that can be based on the goal attributes of a user's productivity based on a user's actual time spent performing the job and also a goal attribute associated with a user's efficiency (e.g., based on a pre-populated efficiency level based on a reference population of similar employees at his level). Additionally, the tempus goal logic associated with a degradation of efficiency based on a fatigue attribute and a stress attribute. The fatigue attribute can be based on readings associated with quality of sleep (from participant's logging of sleep as well as sleep sensors measuring sleep biorhythms), a current health level attribute (e.g., an energy level associated with a health level) as determined by exercise pattern data and biometric sensors providing biometric data associated with cardiovascular readings, blood pressure, etc. The health attribute in turn can be linked to the output of a health goal of reducing weight. In this example, the goal engine 101 can analyze a plurality of possible recommendations to ensure that the tempus goal is met. One possibility is to increase the number of time the user spends working, as the actual time spent in the job directly leads increased productivity at the job. However, as the time at the job increases, efficiency drops, and so do the gains in productivity. Additionally, it neglects other issues contributing to health, sleep, stress reduction, etc., that further accelerate degradation in efficiency. In an alternative, the goal engine 101 can consider actually reducing the amount of time but increasing the goals associated with getting in shape. Thus, instead of a 9 hour work day the participant spends 8 hours at work and one hour exercising. Initially, the reduction in time will result in a reduction in production but over time the energy, stress relief and metal clarity provided by regular exercise provide gains in efficiency such that the participant is actually more productive in a reduced time frame. Additionally, other goals associated with health goals can receive additional benefits.

The following are additional details regarding the calculations used in the example of FIG. 4. In the calculation, values of all the assets and all the expenses/costs are calculated for every current age, for a selected retirement age. These are then compared and if the assets fall below the level required to meet the costs for a particular scenario, then it's a considered a “fail” for the scenario. This process is repeated for each of the 500 scenarios and the result is a distribution based on whether or not the assets will meet liabilities. The likelihood score is the probability that the participant will have enough money to meet their needs in retirement over those 500 scenarios. Each scenario can have differences in various key market assumption categories. Examples of the key market assumption categories can include “Inflation”, “5-Year Treasury Yield”, “10-Year Treasury Yield”, “30-Year Corporate Bond Yield”, “EQ: Int. Equity: World x-U.S.”, “FI: Aggregate Bond”, “FI: Intermediate Gov/Corp. Bond”, “FI: Long Gov/Corp. Bond”, “FI: TIPS”, “FI: Cash”, “EQ:US Equity—Large Cap”, “EQ:US Equity—Small Cap”, “EQ: US Equity—Mid CapValue”, and “Company Stock”.

In addition to embodiments and examples presented elsewhere, the following examples represent various embodiments and use cases of the inventive subject. However, the reader should appreciate the examples do not limit the scope of the inventive subject matter.

In an embodiment, the goal optimization system can be configured such that the goal objects, the determination of a life score and creation of the recommendations are centered around the constraints of available money ($) or available time (T). While other attributes and constraints can be used as a part of the instantiation of goal objects, be used in goal tracking and be used as part of the generation of the recommendations, the ($) constraint, the (T) constraint, or both will be the determining factors with regard to an evaluation of a goal, a progress in a goal, an continued activity in a goal, a reaching of a goal, and a recommendation. Thus, the recommended actions in furtherance of a goal with an availability of money, time, or both as governing factors that trump others.

In embodiments, the goal optimization system can include published APIs that people associated with the participant can subscribe to for the purposes of providing in-bound data in support of one or more goals. For example, a museum for which a participant volunteers can subscribe to the API and track hours that the participant spends performing volunteer work. The museum personnel using the API can use a token to apply the hours to a specific goal. In embodiments, the participants can describe via the API, how the data provided by the museum is in furtherance of the participant's goals. The description can be in terms of a time benefit or financial benefit to the participant based on the goal.

In one example, data feeds from 3rd party “smart clothes” the participant wears is transmitted into entity's goal optimization system infrastructure indicating the amount of miles jogged (GPS) and heart rate elevation. This information could be used in a number of ways including:
a. Validation of fulfillment of health goals, in order to receive an agreed upon discount that is being held in an escrow account. Such information can be presented in a metaphorical port. Example metaphorical portals that can be suitably adapted for use with the inventive subject matter include where benefits are presented within a virtual metaphor as a city. The family virtualized or metaphorical portal might show some weeds in the streets, signifying various family members are behind in some monthly health goals. As the family members go on walks that evening, when they return the GPS wearable devices have already communicated to the portal via the goal optimization system, and the weeds have been turned into flowers.
b. A high level goal example could include establishing a set of practices which can help reduce diabetes risk, with a desired weight loss of 5% over the next 12 months. The details on the set of practices are unique to the individual but within certain guidelines of walking, biking, hiking, weight room efforts, etc. The 5% weight reduction would be a desired outcome, but executing against the set of practices is the real accomplishment to be rewarded.
c. The participant may allow other 3rd parties to see this information anonymously in order to allow then to “bid” on providing various health related services. The participant may then at some point allow some of the 3rd parties to get in actual contact.

A family goal of sending their child to a certain caliber of school may be documented in the goal optimization system infrastructure. This could drive various events such as the following:
a. Recommendations from the goal optimization system infrastructure algorithms or other 3rd party financial companies regarding college savings goals and current funding.
b. Colleges, under the control and supervision of the parents, would have the ability to compete for top students years ahead of time, and give guidance on how the student can best maximize their chances of getting into that college.
c. The participant may allow a broader set of colleges to get “sanitized” (and initially anonymous) details of their child's grades and interests starting early in high school, so that the college can suggest various potential scholarships or describe differentiators the college can provide the student. Feedback from colleges interested in working with the family could be envisaged as the college mascot politely standing inside the family's virtualized metaphorical instance, waiting to be engaged.

The goal optimization system infrastructure can include apps on mobile devices, which could detect (via GPS) when an individual has left a medical provider's facility, and send a query to ask if the interaction with the provider was satisfactory. A strong negative response to the poll could trigger an immediate follow-up from an entity's representative.

The goal optimization system infrastructure can schedule a brief satisfaction poll to be sent to the individual's mobile device, to correspond with when a proposed medical treatment should have proven effective. A strong negative response to the poll could trigger an immediate follow-up from an entity representative.

The participant may decide to allow details derived from wearable sensor data, possibly obtained from the participant's personal area network, on the medicine and consumed food be shared with a health provider or coach, but goal optimization system algorithms might enforce the individual's preference that the carrier and employer are simply to be notified that the user is proactively maintaining meds and is meeting the caloric intake prescribed by the health provider.

In the advent that a goal is slipping, a goal optimization system intelligent agent can transmit alerts the well in advance in order to have a chance to rectify the slippage before there is an obligation to report a failed goal which might have been tied to an incentive.

Among the various “channels”, the participant may give permission for 3rd parties to promote various services or institutional needs that the individual could help satisfy as part of his or her societal goals. A goal optimization system intelligent agent might either surface a potential match for the individual to approve, or perhaps the individual has already granted the entity the ability to make some matches automatically. An example might be an individual who has always wanted to support scientific research in the field of paleontology. The goal optimization system algorithms might detect a match and surface an avatar of a new species of dinosaur standing on the outskirts of metaphorical representation with a collection tin in its hand. The individual can choose to put some fixed amount or a percentage into the collection tin, or ignore the avatar until it vanishes from representation.

As part of the feedback/remuneration cycle between the participant, their goals, and the client that the participant works for, as certain societal goals (such as donation to scientific research) are accomplished, the individuals could receive positive feedback as this is communicated to their company. Even if no remuneration is tied to this, recognition can be its own reward.

The entity would be in a position of gathering and managing information across participants that includes goals, health claims, immediate feedback on services rendered by providers, and perceived success of on procedures and medicines prescribed. This information could be “sanitized” and made available to carriers and pharmaceutical companies to help improve products and services rendered. As an example, clients could negotiate payment structures with incentives/penalties tied to satisfaction surveys regarding the providers in the carrier's network. As another more sophisticated example, pharmaceutical companies could use the feedback along with comprehensive data from the wearable devices to identify issues with medicines prescribed to certain types of individuals, or to identify issues with interactions with certain types of food.

Yet another example includes trans-generational wealth generation. While many employees in Europe may be frustrated that a company will no longer secure their well-being financially until death (defined benefit; i.e., “DB”) they are overlooking a critical factor about defined contribution (“DC”) which is that the money is truly the participants′. If the participants plan wisely, this affords the participant an opportunity to create a better quality of life for their progeny. Related to this, is a service offering that provides setting up an initial DC retirement plans for a participant's children. For a very modest contribution, that participant could give their children a decades long advantage, as a nominal amount of money starts compounding. Imagine every child in the family has his own bank inside metaphorical benefit representation with various accounts, including one for their retirement. An example of a “best practice” archetype goal template might take into account the current finances of the participant, and recommend an initial set up with only a $1 transfer per month. Each year for the next 10 years, an increasing percentage of the participant's raises are directed into this account.

The inventive subject matter can further include a client group “Gamification” to improve employee working/life balance. Or, rollup of departmental data to identify acidic management within a client organization. Such information, possibly including data on sleep results as reported by a wearable device, can be compiled and compares against norms or performance.
a. Two departments within the same company have a number of employees who have volunteered to have their ability to get a restful night's sleep captured, in exchange for a slight discount on their insurance (just for volunteering) along with a discount on the device. The employee data is rolled up and the managers get a general (no individual data) snapshot on how rested their employees are. This leads into the “group level gamification” where a company encourages their employees to chase good habits with managers acting as general cheerleaders (again no individual data).
b. From a company perspective, analytics that one department's people sleep more poorly than the industry average for that type of department (again the entity having a broader perspective across clients) provide a tool to look for acidic management.
c. An entity having or providing analytics on an individual's ability to sleep, could tie that to medical records and outcomes of procedures and medicine given by providers. Among other powerful outcomes, we could sell data (again PII removed) back to pharmaceutical companies on the effects of their medicine of people with good/bad sleep habits, and we can also report on if their medicine had a harmful effect on sleep after it has been prescribed.

The goal optimization system infrastructure can report back to the participant how their sleep/activity data has influenced different research studies, when correlated with medicines the participant is using. This could help further a participant's interest in goals of furthering science (a philanthropic life goal perhaps). One should appreciate that the goal optimization system infrastructure helps facilitate an understanding of how goals are being fulfilled without the participant giving up privacy.

Health goals could be tied into business tools. For example, calendaring and scheduling tools like Microsoft's Outlook can provide the goal engine 101 with the participant's upcoming schedule, analyze upcoming meetings associated with a participant (e.g. duration of meeting, location relative to where participant is expected to be or is typically located prior to the meeting) and correlate this information to the person's fitness goals. The goal engine 101 can be configured to consequently, either via Outlook or another suggestion delivery avenue, suggest that the participants who are co-located go for a “walking meeting” after asking if this is a “voice only” meeting. Outlook can be configured to intentionally make suggestions for meeting rooms in distant locations, or other floors.

The goal optimization system can support compound or team goals. Certain goals may be too large for one participant. However, multiple participants can join in a common effort. A simple example might be a “let's walk together” where a client donates money to charity for miles walked (tracked of course by wearable devices) where the walker is with someone new they have never walked with before (cross-departmental relationship building).

The goal optimization system can support setting future rates based upon group results. Benefit carriers can take part in a “reverse auction” to bid on providing health plans to clients whose participants are showing a trend of improved health (activity, sleep, calories burned, % of meetings performed while walking, etc.).

Using the system, an employer can set up grouped scores for groups of employees (e.g., departmental, geographical, or company-wide) and according to a common set of goals. As such, the employer can get a feel for a level of goal progress with regard to one or more aspects of life for their employees generally. This company score can be used to feed into benchmarking indexes for industry-wide scoring, for future fluctuations tied to productivity, employee morale, etc.

In a variation of this example, the system can provide an automatic modification of benefits offerings based on an employee's progression through their goals. For example, a new employee can be offered a default health plan having conditions tied to an average population's characteristics. As the employee's health improved due to completion of health-related goals, the benefits can automatically change to adapt to the employee's needs. Similarly, the benefits can adapt to account for degradation in health due to aging or due to the occurrence of life events.

The goal optimization system can also support sending data to wearable devices or target personal area networks, in support of participants' goals. An example might be to configure office chairs to “alert” the user based upon inactivity at the agreed upon times.

Forward thinking managers of clients may very well want to run sanitized analysis of the number (or percentage) of employees in their care who have set life-goals whether financial, personal, health, societal, family, or legacy related. This quantifiable analysis of employee self-improvement can give evidence to the value of the leadership a particular manager provides his company.

The following points represent addition points of consideration with respect to the inventive subject matter:

In embodiments, the contemplated system can support tax incentives such as goals associated with tax contributions, tax benefits associated with fitness or health plans, tax benefits associated with varying levels of retirement benefit plan attributes, etc.

In embodiments, the contemplated system can derive recommendations based on matched cultural drivers. Cultural drivers can be considered attributes associated with a culture (e.g. company culture, geographical culture, national culture, ethnic culture, etc.) that can be serve to modify a goal based on what cultural norms consider to be relevant or important.

In embodiments, the contemplated systems can support creating evidence-based negotiation points between a participant and one or more employers. The negotiation points can be derived based on a participant's goals progress (including achieved goals) and an employer's attributes that can be affected by the participant's goals. This can include achieving employer-set goals directly. This can also include making progress towards goals that result in a benefit to the employer (e.g. lower insurance costs, greater productivity, etc.).

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A goal optimization system comprising:
a participant database configured to store participant data from a plurality of participants;
a goal database configured to store a plurality of goal objects associated with the plurality of participants, and a plurality of goal templates corresponding to a plurality of goal channels;
a participant interface; and
a goal engine embodied as computer-executable instructions stored on a non-transitory computer-readable medium, communicatively coupled with the participant database, the participant interface, and the goal database, wherein the instructions, when executed by the processor, cause the processor to:
receive a first set of participant attributes and a second set of participant attributes from a target participant via the participant interface, wherein the first set of participant attributes includes a first goal channel attribute and the second set of participant attributes includes a second goal channel attribute;
instantiate a first goal object as a function of the first set of participant attributes and a first goal template from the plurality of goal templates selected according to the first goal channel attribute, the first goal object comprising a first set of goal attributes and having a first desired outcome and corresponding to a first goal channel;
instantiate a second goal object as a function of the second set of participant attributes and a second goal template from the plurality of goal templates selected according to the second goal channel attribute, the second goal object having a second set of goal attributes and having a second desired outcome and corresponding to a second goal channel different from the first goal channel;
correlate at least one first goal attribute from the first set of goal attributes and at least one second goal attribute from the second set of goal attributes according to correlation rules;
generate a first goal outcome likelihood for the first goal object as a function of the first desired outcome by comparing the first set of goal attributes to corresponding attribute sets of goal objects associated with at least some of the plurality of participants;
generate a second goal outcome likelihood for the second goal object as a function of the second desired outcome by comparing the second set of goal attributes to corresponding attribute sets of goal objects associated with at least some of the plurality of participants;
generate a life score for the participant as a function of the first goal outcome likelihood of the first goal object and second goal outcome likelihood of the second goal object;
modify at least one first goal attribute from the first set of goal attributes including the at least one correlated first goal attribute;
generate a first hypothetical goal outcome likelihood as a function of the first desired outcome by comparing the modified at least one first goal attribute to the corresponding attribute sets of goal objects associated with at least some of the plurality of participants;
modify the at least one correlated second goal attributes as a function of the modified at least one correlated first goal attribute;
generate a second goal hypothetical outcome likelihood as a function of the second desired outcome by comparing the modified at least one second goal attribute to the corresponding attribute sets of goal objects associated with at least some of the plurality of participants;
generate a hypothetical life score for the participant as a function of the first hypothetical goal outcome likelihood and the second hypothetical goal outcome;
determine that the first hypothetical goal outcome likelihood is greater than the generated first goal outcome likelihood and the hypothetical life score is greater than the generated life score;
generate at least one goal recommendation based on the generated life score, at least one first goal attribute from the first set of goal attributes and at least one second goal attribute from the second set of goal attributes, wherein the at least one goal recommendation includes the modification to the at least one first goal attribute used to generate the first hypothetical goal outcome likelihood; and
configure the participant interface to present the goal recommendation.

2. (canceled)

3. (canceled)

4. The system of claim 1, wherein the at least one first goal attribute and the at least one second goal attribute comprise attributes of a same attribute type.

5. (canceled)

6. The system of claim 1, wherein the at least one first goal attribute comprises an output attribute corresponding to an output associated with the first goal object and wherein the at least one second goal attribute comprises an input attribute for the second goal object, the input attribute derived based on the output attribute.

7. The system of claim 1, wherein the first goal object further includes a first goal priority attribute representative of a priority of the first goal object, the second goal object further includes a second goal priority object representative of a priority of the second goal object, and wherein the first goal priority attribute and the second goal priority attribute are representative of different priority levels.

8. The system of claim 7, wherein the goal engine is configured to generate the life score as a function of at least one of the first goal attributes, the first goal priority attribute, at least one of the second goal attributes, and the second goal priority attribute.

9. The system of claim 8, wherein the first goal priority attribute comprises a first weighting factor applied to the at least one first goal attribute and the second goal priority attribute comprises a second weighting factor applied to the at least one second goal attribute.

10. The system of claim 1, wherein the first goal object and the second goal object each comprise a different one of at least one of the following: a benefit goal, a financial goal, a legacy goal, a societal goal, a health goal, a family goal, a personal goal, and a team goal.

11. The system of claim 1, wherein the participant attributes comprise at least one of demographic attributes, psychographic attributes, biometric attributes, financial attributes, personality attributes, relationship attributes, personal attributes, and family attributes.

12. The system of claim 1, wherein the participant data comprises psychographic attributes.

13. The system of claim 1, wherein the participant data comprises biometric data.

14. The system of claim 1, wherein the target participant comprises a client.

15. The system of claim 1, wherein the target participant comprises an employee.

16. The system of claim 1, wherein the participant interface comprises at least one of the following: a cell phone, a browser-enabled computing device, a workstation, and a server.

17. The system of claim 1, wherein the goal recommendation includes a suggested action to be taken by the target participant that results in the modification of the at least one first goal attribute.

18. The system of claim 1, wherein the goal recommendation includes a modification to at least one of the first goal attributes and second goal attributes that would increase the life score.

19. The system of claim 1, wherein the second hypothetical goal outcome likelihood comprises a temporary reduction of the second goal outcome likelihood.

20. The system of claim 1, wherein the first goal channel comprises a non-financial channel and the second goal channel comprises a financial channel.
